(19) United States
(12) Patent Application Publication
(10) Pub. No.: US 2020/0205397 A1
(43) Pub. Date: Jul. 2, 2020

(54) TREE STAND SUPPORT AND METHOD OF USE THEREOF

(71) Applicant: Charles B. Adams, Lafayette, TN (US)

(72) Inventor: Charles B. Adams, Lafayette, TN (US)

(21) Appl. No.: 16/727,376

(22) Filed: Dec. 26, 2019

Related U.S. Application Data
(60) Provisional application No. 62/917,742, filed on Dec. 26, 2018.

(51) Int. Cl. A01M 31/02; A45F 3/26

(52) U.S. Cl. CPC A01M 31/02; A45F 3/26

(57) ABSTRACT

A device for providing additional support for the lower horizontal platform of a tree mounted hunting stand of the type where the lower horizontal platform is supported by cables. The device has a front member to be attached to the lower horizontal platform of a tree mounted hunting stand of the type where the lower horizontal platform is supported by cables; a toothed member for engagement with the tree; an adjustable length strut attached at one end thereof to the front member and at the other end thereof to the toothed member. A method for providing additional support for the lower horizontal platform of a tree mounted hunting stand of the type where the lower horizontal platform is supported by cables. The front member of the device of claim 1 is attached to the lower horizontal platform of a tree mounted hunting stand of the type where the lower horizontal platform is supported by cables and the length of the adjustable length strut is adjusted so that the toothed member engages with the tree below the lower horizontal platform.

### CROSS-REFERENCE TO RELATED APPLICATION

This application claims the benefit of U.S. Provisional Application No. 62/917,742, filed Dec. 26, 2018, and which is hereby incorporated by reference in its entirety.

### TECHNICAL FIELD

This disclosure relates to elevated tree stands for use in hunting and other activities.

### BACKGROUND

A typical tree stand consists of a vertical frame, a lower horizontal platform, and an upper horizontal platform. The vertical frame is mounted to the trunk of a tree or other vertically-extending structure, such as by a cinched strap. The lower horizontal platform is hinged to the lower portion of the vertical frame and supported and maintained in the horizontal position by cables that extend to the upper portion of the vertical frame. The upper horizontal platform is attached to the upper portion of the vertical frame and functions as a seat; the lower horizontal platform supports the feet of the user, and is often stood upon, thereby bearing the entire weight of the user and his or her gear.

### SUMMARY

A method for use with a tree stand mounted to a tree and having a generally horizontal platform supported by cables is provided. The method includes attaching a support to the platform; and causing the support to contact the tree.

A corresponding apparatus includes a front member to be attached to the platform, a toothed member for engagement with the tree, and an adjustable length strut system attached at one end thereof to the front member and at the other end thereof to the toothed member.

The apparatus and method provided herein improve upon the prior art by increasing the safety of tree stands of the type wherein a platform is supported entirely by, or mostly by, cables. Tree stands are often installed and then left for years at a hunting location. The cable system supporting the lower horizontal platform can thereby deteriorate from exposure to the elements. If the cable system supporting the lower horizontal platform fails when a hunter is standing on the lower horizontal platform, the hunter will fall from the tree and suffer injury or death.

The apparatus and method may be installed after the tree stand is attached to a tree, and provides more robust support than the cables. More specifically, the apparatus provided herein is more resilient and less likely to degrade due to exposure than cables. Furthermore, the apparatus provided herein is significantly stronger than cables, and thereby significantly increases the maximum load that can be supported on the platform.

The above features and advantages and other features and advantages of the present disclosure are readily apparent from the following detailed description of the best modes for carrying out the disclosure when taken in connection with the accompanying drawings

### BRIEF DESCRIPTION OF THE DRAWINGS

FIG. 1 is a schematic, perspective view of a tree stand support in accordance with the claimed invention in use with a tree stand;

FIG. 2 is a schematic, top view of an alternative embodiment of the tree stand support in accordance with the claimed invention;

FIG. 3 is a schematic, perspective view of another alternative embodiment of the tree stand support in accordance with the claimed invention; and

FIG. 4 is a schematic, perspective view of the tree stand support in use with another tree stand.

### DESCRIPTION OF THE PREFERRED EMBODIMENTS

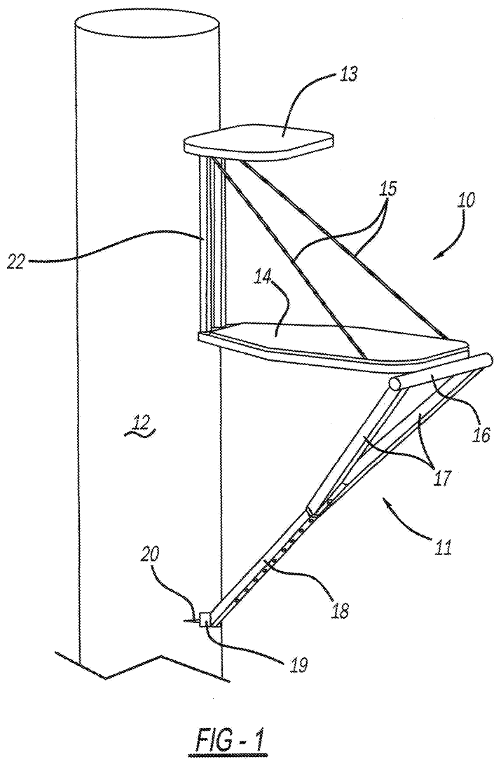

Referring now to FIG. 1, therein is shown a tree mounted hunting stand, or “tree stand,” 10 with a tree stand support 11 of the instant invention. The tree stand 10 includes a seat 13, a lower horizontal platform 14, and an upright, vertical frame assembly 22. It should be noted that, within the scope of the claimed invention, a “frame assembly” may include a single frame member or a plurality of members operatively interconnected. The seat 13 is attached to an upper portion of the vertical frame assembly 22. Lower horizontal platform 14 is attached to the lower portion of the frame assembly 22. Cables 15 extend from an upper portion of vertical frame assembly 22 to lower horizontal platform 14 to support lower horizontal platform 14 when a hunter stands on lower horizontal platform 14. Vertical frame assembly 22 is attached to tree 12 by a strap or other means as understood by those skilled in the art.

Referring still to FIG. 1, the tree stand support 11 includes a front member 16, a strut system having sections 17, 18, 19, and a toothed member 20. The front member 16 is shown attached to the lower horizontal platform 14. Toothed member 20 is shown engaged with tree 12. The length of adjustable length strut system 17, 18 and 19 is adjusted so that toothed member 20 engages with tree 12 below lower horizontal platform 14.

In use, a hunter or other user of the tree stand 10 stands on the lower platform 14; the weight of the hunter and his or her equipment results in a downward force exerted onto the platform 14. The support 11 is positioned to transfer the downward force to the tree 12 through the strut system and the toothed member 20.

Referring to FIG. 2, wherein like reference numbers refer to like components from FIG. 1, therein is shown a top view drawing of an alternative embodiment of a tree stand support 11A showing front member 16, toothed member 20, and adjustable length strut system having sections 17, 18, 19, 17a and 17b. Strut section 18 is provided with holes therethrough along the length of strut section 18. Two strut sections 17 are connected to a tubular section 17A such that the sections 17 diverge from each other with distance from the tubular section 17a. The front member 16 is connected to, and extends between, the two struct sections 17. Strut section 18 is slidable in tubular section 17a. The length of the strut is fixed by bolt 17b. More specifically, a user may adjust the length of the strut assembly by sliding member 18 through the tubular section 17a, and extending the bolt 17b through one of the holes in section 18 to limit any further movement of section 18 with respect to the tubular section 17a, thereby locking the strut assembly at a desired length. Toothed member 20 is supported by backing plate 19 attached at the end of strut section 18. Although toothed member 20 is shown having a plurality of teeth or projections, it should be understood that the toothed member of the instant invention can have one or more teeth or projections.

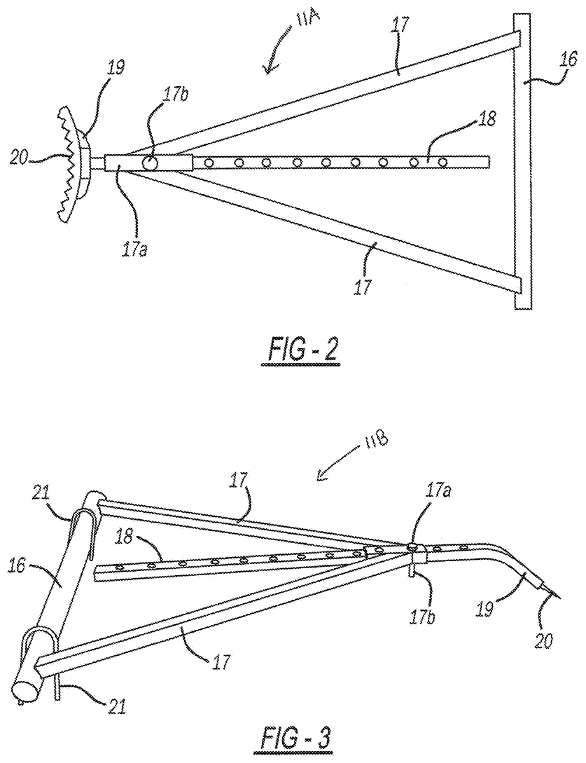

Referring now to FIG. 3, wherein like reference numbers refer to like components from FIGS. 1 and 2, therein is another embodiment of the tree stand support 11B including front member 16, adjustable length strut system having sections 17, 18, 19, 17a and 17b, backing plate 19 and toothed member 20. U-bolts 21 are used to attach front member 16 to the lower horizontal platform of the tree stand.

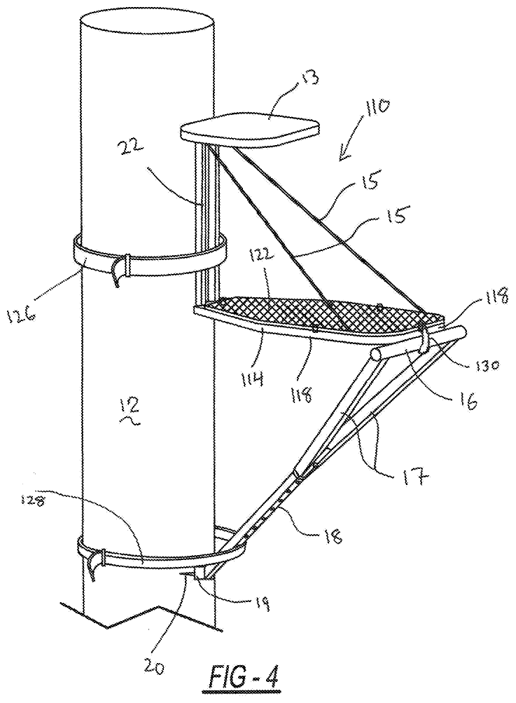

Referring to FIG. 4, wherein like reference numbers refer to like components from FIGS. 1-3, a tree stand 110 is mounted to a tree 12. The tree stand 110 is substantially identical to the tree stand shown at 10 in FIG. 1, except that the lower horizontal platform 114 is shown as having a frame member 118 that forms the perimeter of the platform 114. Metallic mesh 122 is connected to the frame member 118 and forms the surface upon which a hunter or other user may stand. A cinched strap 126 encircles the tree 12 and the vertical frame member 22 to secure the tree stand 110 to the tree 12.

Another cinched strap 128 is employed to secure the toothed member 20 to the tree. The front member 16 is attached to the platform 114 by an industrial-strength zip-tie 130. The zip-tie 130 encircles the front member 16 and the frame member 118, thereby attaching the support 11 to the platform 114.

Referring to FIGS. 1 and 4, a method of using the support 11 includes attaching the support 11 to the platform (14, 114), and causing the support 11 to contact the tree 12. In the embodiments depicted, causing the support 11 to contact the tree 12 includes causing the support 11 to contact the tree 12 below the platform 14, 114. The support 11 includes a first portion, i.e., the toothed member 20, and a second portion, i.e., the front member 16. The first portion includes at least one tooth. Causing the support 11 to contact the tree 12 includes causing said at least one tooth 20 to contact the tree 12.

Attaching the support 11 to the platform 14, 114 includes attaching the second portion, i.e., front member 16, to the platform 14, 114 such that the second portion is higher than, and further from the tree 12 than, the first portion, i.e. toothed member 20. In the embodiments shown, the front portion 16 is attached to the platform at the end of the platform that is furthest from the tree 12. The support 11 includes structure, i.e., the strut system, interconnecting the first portion 20 and the second portion 16. The structure is configured such that the length of the device 11 is selectively variable. The method may also include attaching the toothed member 20 to the tree, such as via the strap 126 shown in FIG. 4.

The device of the instant invention can be made of any suitable material such as the painted welded steel construction of the device shown in FIG. 3. Strut section 18 of the device shown in FIG. 3 is 0.75 inch square 0.065 inch thick square steel tubing, strut sections 17 and 17a are 1.0 inch square 0.065 inch thick square steel tubing, toothed member 20 and backing plate 19 are formed from 0.125 inch thick steel plate, and front member 16 is formed from 1.0 inch round 0.065 inch thick steel tubing. When tested with a tree mounted hunting stand of the type where the lower horizontal platform is supported by cables, the lower horizontal platform of the tree stand supported a 3,000 pound weight on the lower horizontal platform without failure. Without the support 11, a tree stand 10 can typically support less than 300 pounds before failure of the cables 15.

While the best modes for carrying out the invention have been described in detail, those familiar with the art to which this invention relates will recognize various alternative designs and embodiments for practicing the invention within the scope of the appended claims.

1. A method for use with a tree stand mounted to a tree and having a generally horizontal platform, the method comprising:
attaching a support to the platform; and
causing the support to contact the tree.

2. The method of claim 1, wherein said causing the support to contact the tree includes causing the support to contact the tree below the platform.

3. The method of claim 2, wherein the support includes a first portion and a second portion;
wherein the first portion includes at least one tooth; and
wherein said causing the support to contact the tree includes causing said at least one tooth to contact the tree.

4. The method of claim 2, wherein said attaching the support to the platform includes attaching the second portion to the platform such that the second portion is higher than, and further from the tree than, the first portion.

5. The method of claim 4, wherein the support includes structure interconnecting the first portion and the second portion; and
wherein the structure is configured such that the length of the support is selectively variable.

6. An apparatus for use with a tree stand having a horizontal platform, the apparatus comprising:
a front member to be attached to the platform;
a toothed member for engagement with the tree; and
an adjustable length strut system attached at one end thereof to the front member and at the other end thereof to the toothed member.
